(19) United States
(12) Patent Application Publication
(10) Pub. No.: US 2022/0238906 A1
(43) Pub. Date: Jul. 28, 2022

(54) BIPOLAR AQUEOUS INTERCALATION BATTERY DEVICES AND ASSOCIATED SYSTEMS AND METHODS

(71) Applicant: BenAn Energy, Shanghai (CN)

(72) Inventors: Thomas H. Madden, Glastonbury, CT (US); Karl Oleson, Seattle, WA (US); Honorio Valdes-Espinosa, Seattle, WA (US); David Hurt, Seattle, WA (US); Jian He, Taicang City (CN); Xiaorui Hou, Shanghai (CN)

(21) Appl. No.: 17/587,962

(22) Filed: Jan. 28, 2022

Related U.S. Application Data
(60) Provisional application No. 63/142,844, filed on Jan. 28, 2021.

(51) Int. Cl. H01M 10/04; H01M 50/184; H01M 50/186; H01M 4/66; H01M 50/193; H01M 10/36

(52) U.S. Cl. CPC H01M 10/0468; H01M 50/184; H01M 50/186; H01M 4/667; H01M 2004/029; H01M 4/663; H01M 50/193; H01M 10/36; H01M 4/668

(57) ABSTRACT

A bipolar aqueous intercalation battery (AIB) is disclosed herein. The AIB can comprise an anode, a cathode, a separator disposed between the anode and the cathode, a frame surrounding the anode, the cathode and the separator, and bipolar layers including a first bipolar layer at a first side of the frame and a second bipolar layer at a second side of the frame opposite the first side. The first bipolar layer and the second bipolar layer each abut the frame, such that the frame, the first bipolar layer and the second bipolar layer together are configured to contain an electrolytic fluid and form a water-tight seal around the anode, the cathode, and the separator.

### CROSS-REFERENCE TO RELATED APPLICATIONS

The present application claims the benefit of U.S. Provisional Patent Application No. 63/142,844, filed Jan. 28, 2021, the disclosure of which is incorporated herein by reference in its entirety.

### TECHNICAL FIELD

The disclosed technology relates to energy storage devices, and more specifically, to battery energy storage devices incorporating aqueous intercalation battery materials in a bipolar configuration.

### BACKGROUND

Aqueous intercalation batteries (AIB) are an emerging battery technology that involves the use of ceramic-based active materials capable of ion exchange functionality and which operate in a safer, lower cost aqueous electrolyte. However, the use of aqueous electrolytes requires the use of lower voltage electrochemical couplers, and generally limits the cell voltage of these systems to less than 2.0V per cell at top-of-charge (TOC). This limits the energy density of these batteries, and therein presents a barrier to a cost-effective battery. Additionally, although bipolar battery configuration provides advantages in power capacity, weight, and volume in comparison to the traditional mono-polar batteries, mono-polar batteries are still dominant in the battery industry due to their ease of manufacturing in a controlled environment, and ability to be individually controlled and monitored, which is critical when using traditional Lithium Ion Battery (LIB) technology. As a result, there is a need to improve the energy density and lower manufacturing costs of AIBs to make more economically viable.

### BRIEF DESCRIPTION OF THE DRAWINGS

FIG. 1A shows a partially schematic front view of an example of a bipolar AIB device, and FIG. 1B shows a cross-sectional view of the device along line 1B of FIG. 1A, according to various embodiments described herein.

FIG. 1C is front view of each of the individual components of the device shown in FIGS. 1A and 1B, according to various embodiments described herein.

FIG. 1D shows the device of FIGS. 1A and 1B further including electrolyte fluid, and FIG. 1E is a cross-sectional view of the device shown in FIG. 1D along line 1E, according to various embodiments described herein.

FIG. 2 shows a partially schematic exploded view of an example of a bipolar AIB block according to various embodiments described herein.

FIG. 3 shows a partially schematic view of an example of a portion of a compressible sealable frame, according to various embodiments described herein.

FIG. 4 shows a partially schematic view of an example of a gas ventilation system of a bipolar AIB stack, according to various embodiments described herein.

FIG. 5 shows a partially schematic view of an example of a bipolar AIB stack, according to various embodiments described herein.

A person skilled in the relevant art will understand that the features shown in the drawings are for purposes of illustrations, and variations, including different and/or additional features and arrangements thereof, are possible.

In the Figures, identical reference numbers identify generally similar, and/or identical, elements. Many of the details, dimensions, and other features shown in the Figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

### DETAILED DESCRIPTION

### I. Overview

The disclosed technology provides an innovative battery cell, block, and stack that attempts to leverage the stability and safety of AIB technology together with improvements on bipolar battery technology to create a high performance and cost-effective battery product. As described in detail herein, the disclosed technology relates to improvements on AIB technology, e.g., by employing a low-resistance bipolar design, resulting in enhanced power, energy efficiency, and design flexibility. The disclosed technology also relates to improvements on bipolar battery (BPB) technology by enabling the use of cost-effective materials, and a frame having compressible and water-tight sealing ability. In some embodiments, the frame is made of a single, integrated piece and therefore, can be easily produced in a cost-effective way, e.g., by injection molding, while also providing a water-tight seal. The frame can also be more resilient to thickness tolerance requirements than conventional materials used in sealing frames. The frame can result in improved manufacturability and enable a flexible design, such that a single repeatable manufacturing sequence can be used to produce batteries of a wide variety of voltage and capacity specifications. Embodiments of the present technology can employ an aqueous electrolyte system, which enables the use of more durable and cost-effective materials for the frames and bipolar layers (BPLs).

The disclosed technology improves on the energy density as well as energy efficiency of comparable designs, which in some embodiments is achieved through the bipolar layer's reduced series-resistance values compared to those of monopolar batteries. For example, whereas a monopolar AIB battery cell may have a top of charge resistance of 1.2 Ohms per cell, a corresponding bipolar AIB battery cell may have a top of charge resistance of 1.0 Ohms per cell. In addition, the high conductivity of the AIB electrolyte of the disclosed technology allows for substantially more electrode loading relative to traditional LIB technologies. In some embodiments, for example, the electrode loading can be at least 50 mg/cm², 100 mg/cm², 200 mg/cm², 300 mg/cm², 400 mg/cm², 500 mg/cm², and/or within a range of 100-500 mg/cm². This is compared to a typical electrode loading of 10-30 mg/cm² in traditional lithium-ion cells. Additionally or alternatively, embodiments of the disclosed technology can have lower resistance relative to traditional LIB technologies.

### II. Bipolar Design

Existing AIB technology generally involves the use of a mono-polar battery (MPB) current collection scheme to build parallel capacity before building voltage in series. In this MPB scheme, the adjacent layers of electrodes are electrically connected in parallel through the means of separate metal current collector busses (e.g., one metal current collector bus for the anode and another metal current collector bus for the cathode) in a single cell. In such MPB embodiments, each current collector for the anode or cathode is a mono-pole and must be connected in parallel to achieve a desired voltage. As a result, current for these systems is passed through these connections, which detrimentally leads to significant resistive losses for the overall system. Moreover, most AIB MPB designs also connect adjacent electrode layers to the bus with different lengths of metal current collector, thereby leading to different layers having different impedances and lifetimes.

The disclosed technology addresses many of these and other deficiencies often associated with AIB MPB designs. Embodiments of the disclosed technology utilize a bi-polar battery (BPB) scheme, wherein adjacent layers of a battery stack can be electrically connected in series with one another such that the current flows directly from one layer to the next. As such, each current collector is exposed to a cathode environment on one side, and to an anode environment on the other side. This series connection constitutes a very short distance and can thereby result in relatively little resistive loss, relative to the related conventional AIB MPB technologies. The capacity for a given stack can be built up and/or tailored to a desired end use, e.g., by expanding these anode and cathode material quantities in the plane of an individual cell, and/or by parallel connections of series cell blocks.

### III. Battery Cells

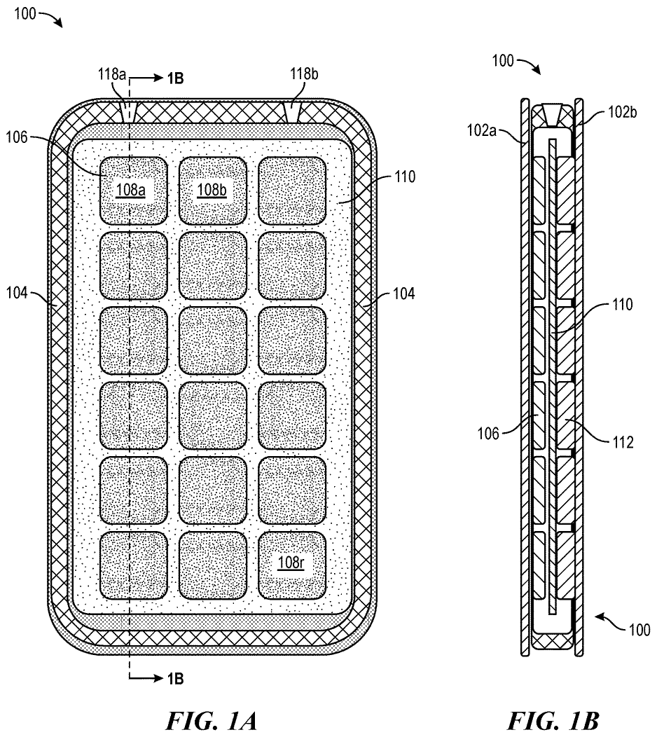

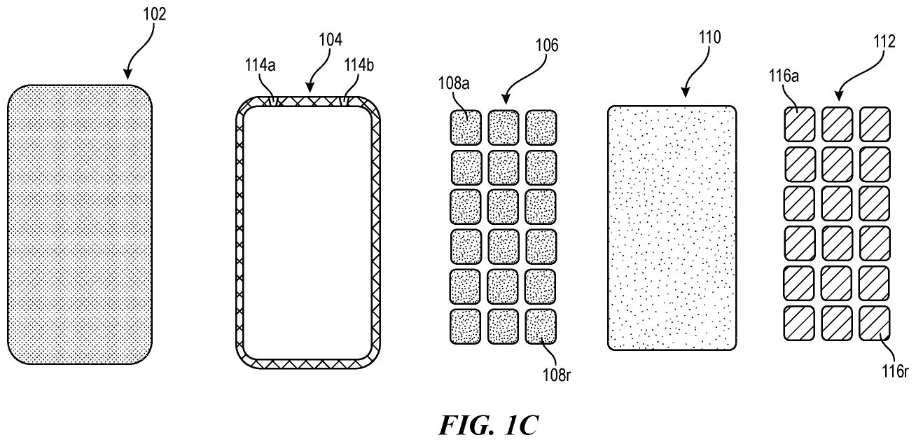

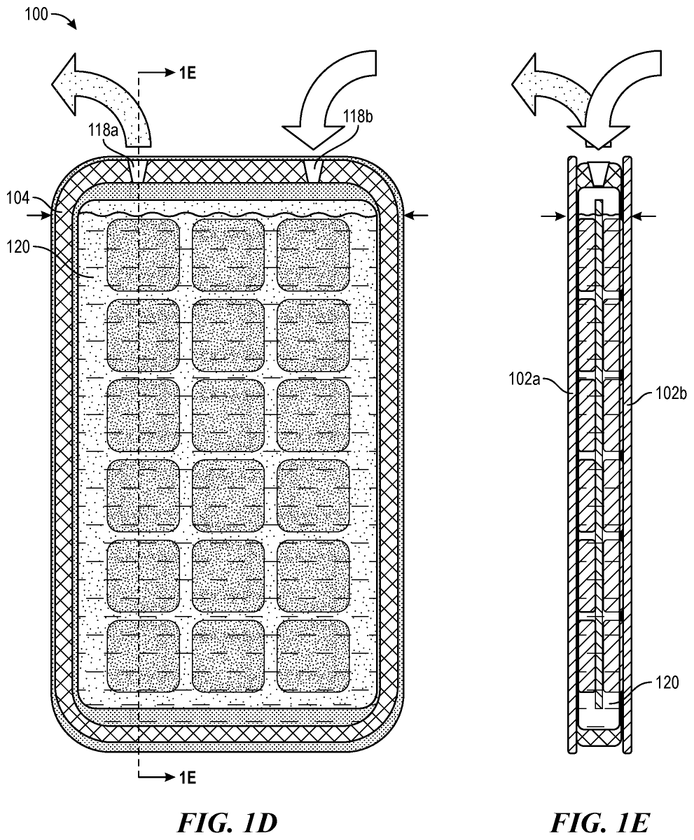

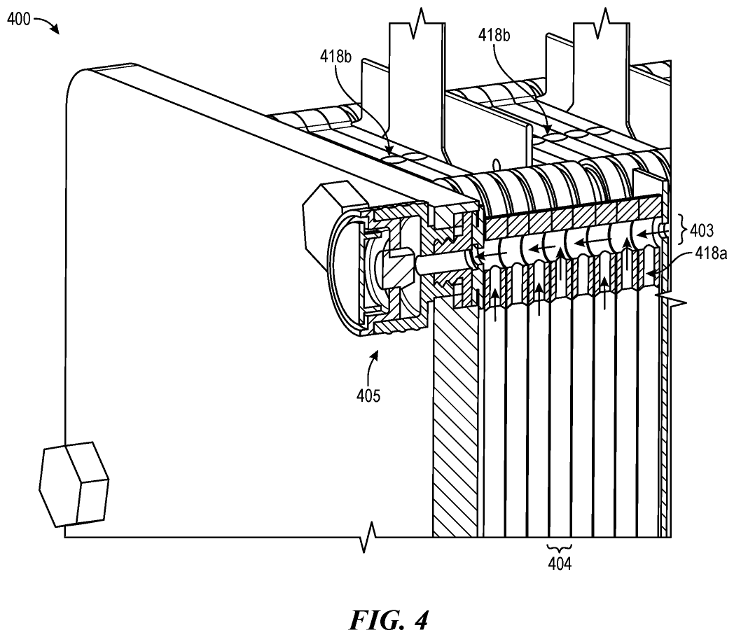

FIG. 1A shows a partially schematic front view of an example of a bipolar AIB device 100 (“the device 100”), FIG. 1B shows a cross-sectional view of the device 100 along line 1B of FIG. 1A, and FIG. 1C is front view of each of the individual components of the device 100, according to various embodiments described herein. Referring to FIGS. 1A-1C together, the device 100 can be used for building bipolar AIB stacks (e.g., the bipolar AIB stacks disclosed elsewhere herein with reference to FIG. 4). The device 100 can include an anode electrode 106 (“anode 106”), a cathode electrode 112 (“cathode 112”), and a separator 110 positioned between the anode 106 and cathode 112. The anode 106, separator 110, and cathode 112 together comprise a battery cell. The device 100 can further comprise a frame 104 encapsulating the battery cell, and bipolar layers (BPL) 102a,b (collectively referred to as “bipolar layers 102”) positioned adjacent and outward of the battery cell and frame 104.

The anode 106 can be an intercalation-type negative electrode and the cathode 112 can be an intercalation-type positive electrode. In some embodiments, the anode 106 and/or the cathode 112 include free-standing sheets, pellets, and/or or coatings, and comprise water-stable intercalation materials and/or conductive carbons for electrical contact. Additionally or alternatively, the anode 106 and/or the cathode 112 can comprise binding materials. The anode 106 can comprise an ion conducting material, sodium titanium phosphate (STP), lithium titanate (LTO), metal-cyano complexes (e.g., the Prussian-blue class of metal-cyano complexes), materials of the general stoichiometry TiₓP_{y}O_{z}, or mixtures thereof. Additionally or alternatively, the anode 106 can comprise an intercalating material (e.g., an intercalating ceramic). The cathode 112 can comprise any common cathode intercalation materials used for lithium ion batteries, including Li-containing oxide composition of lithium manganese oxide (LMO), nickel-manganese-cobalt (NMC), nickel-cobalt-aluminum (NCA), iron-phosphate (LFP), cobalt (LCO), sodium conducting materials (e.g., the Prussian-blue class of metal-cyano complexes, sodium-manganese-titanium-phosphate (NMTPO), or sodium manganese oxide (NMO)), and/or combinations thereof.

As shown in FIG. 1C, the anode 106 can include an array of anode electrode portions 108a-r (collectively referred to as “anode electrode portions 108”), and the cathode 112 can include an array of cathode electrodes portions 116a-r (collectively referred to as “cathode electrode portions 116”). Each of the anode electrodes portions 108 and/or cathode electrode portions 116 can be evenly spaced apart from one another, e.g., in a horizontal and/or vertical direction. In some embodiments, each of the anode electrode portions 108 and/or cathode electrode portions 116 can have at least four sides and/or generally correspond to a square or other shape that maximizes surface area of the individual portions on the respective anode 106 or cathode 112. In some embodiments, each side of the anode electrodes portions 108 and/or cathode electrode portions 116 can have a length dimension of at least 1 cm, 2 cm, 3 cm, 4 cm, 5 cm, or within a range of 1-5 cm. The number of anode electrode portions 108 can be the same of differ from the number of cathode electrode portions 116.

The anode 106 and/or cathode 112 can be formed using the materials disclosed herein via methods including extrusion, compression, or a combination thereof. For example, forming the anode 106 and/or cathode 112 can comprise combining the materials disclosed herein with one or more conductive carbon materials (e.g., flake graphite, carbon black, acetylene black, or activated carbon) and one or more binding materials (e.g., PTFE or PFA). The carbon and binding materials may be chosen based on desired activity, conductivity, and structural properties of the anode 106 and/or cathode 112.

The separator 110 can be a porous separator that enables both electronic isolation and ionic conductivity within the cell. In some embodiments, the separator 110 can comprise a woven or non-woven cotton sheet, polyvinyl chloride (PVC), polyethylene (PE) glass fiber or other suitable material(s). The separator 110 can be substantially the same size as the anode 106 and/or the cathode 112.

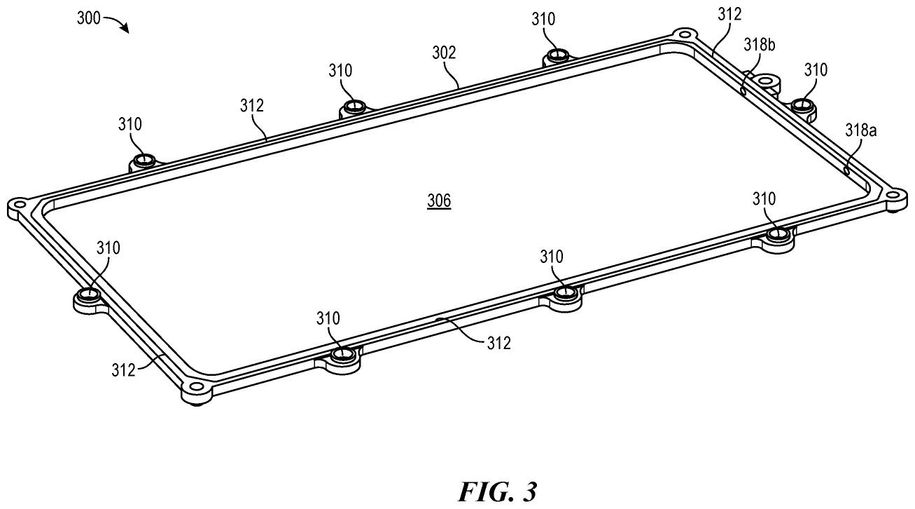

The frame 104 can comprise a compressible sealable frame (CSF) and can be a single, integrated structure. The frame 104 can include one or more openings or holes, including a first opening 118a configured to enable gas to escape from the area encapsulated by the frame 104 during operation, a second opening 118b configured to receive fluid (e.g., electrolyte fluid), as described in additional detail herein (e.g., with reference to FIG. 3). The frame 104 can be made of a compressible material to create a mechanical seal against the layer or material proximal thereto. As explained in detail elsewhere herein (e.g., with reference to FIGS. 1D and 1E), the frame 104 can form a mechanical seal against one or more bipolar layers that is water-tight, thereby enabling aqueous electrolyte to fill or “flood” the cell sealed by the frame 104, such that the anode electrode portions 108 and/or cathode electrode portions 116 are drowned or surrounded by the electrolyte.

In some embodiments, the frame 104 comprises an elastomer (e.g., rubber, silicone rubber, isoprene, neoprene, ethylene propylene diene monomer (EPDM) rubber) or other related compressible materials. Using such material(s) enables the frame 104 to form a water-tight seal around the battery cell without the need for separate mechanical sealing parts, such as O-rings, gaskets, dual-material frames, or other sealing means (e.g., thermal welding, adhesive bonding, or a combination thereof) which are used in conventional bipolar battery frames. Conventional battery frames are often made of rigid materials that must be sealed using other sealing means, or a combination of rigid materials which provide support and a separate compressible material which provides a seal. Due in part to the use of a single type of material that provides both support and sealability, the device 100 disclosed herein is easier to manufacture and has lower manufacturing costs.

As shown in FIGS. 1A and 1B, a perimeter of the frame 104 is disposed around (e.g., peripheral to) edges of the anode 106, separator 110, and cathode 112 such that these components are surrounded by the frame 104. In some embodiments, the thickness and compressibility of frame 104 is determined such that, when the stack is under full compression, the thickness of the frame 204 will be approximately the same as the combined thickness of the anode 106, separator 110, and cathode 112. That is, the combined thickness of the anode 106, separator 110, and cathode 112, when not under a compressed state, will be approximately equal to the thickness of the frame 104 in a compressed state.

As previously described, in some embodiments the frame 104 is made of a single, integrated piece and therefore, can be easily produced in a cost-effective way, e.g., by injection molding. The frame 104 can also be more resilient to thickness tolerance requirements than other materials often used in sealing frames. The frame 104 can also result in improved manufacturability and flexible design such that a single repeatable manufacturing sequence can be used for a wide variety of battery applications having various voltage and capacity specifications.

As previously described, the device 100 can further include bipolar layers (BPL) 102a,b (collectively referred to as “bipolar layers 102”). As shown in FIGS. 1A and 1B, a first bipolar layer 102a can be positioned adjacent the anode 106 and proximate a first side of the frame 104, and a second bipolar layer 102b can be positioned adjacent the cathode 112 and proximate a second, opposing side of the frame 104. In some embodiments, each of the bipolar layers 102 may extend to the edge of the frame 104 and facilitate sealing of the device 100. In operation, each of the bipolar layers can connect the device 100 to an adjacent cell and effectively act as a current collector. In such embodiments, each of bipolar layers 102 may be positioned between adjacent cells to electrically couple the cells to one another, thereby transferring electrons directly from an anode of one cell to a cathode of an adjacent cell in series. In such embodiments, the beginning and ends of the bipolar stack can require monopolar style current collectors. Advantageously, as more cells are connected in series, the overall impedance seen in the BPL designs is increasingly reduced. This is because more energy is passed “through-plane” as opposed to “in-plane” (e.g., along a length or width of a component of the cell).

The compressibility of the frame 104, as well as its thickness, can allow for design-control over compression of the anode 106, separator 110, and cathode 112, while maintaining a tight seal throughout a lifetime of the device 100. In some embodiments, the combined thickness of the anode 106, separator 110, and cathode 112 may be from 1.0-6.0 mm. In some embodiments, the uncompressed combined thickness of the anode 106, separator 110, and cathode 112 is 4.0 mm, and the expected compressed thickness can be at least 5% to a final thickness of no more than 3.8 mm, 3.7 mm, 3.6 mm, 3.5 mm, 3.4 mm, or 3.3 mm. In some embodiments, a low-durometer frame 104 having a thickness of 4.5 mm may be used, and so could be compressed 20% to the thickness of 3.6 mm. A higher durometer frame 104 having a thickness of 3.8 mm may experience less relative compression but would exhibit the same final result, albeit with potentially different lifetime properties (e.g., with regard to sealing and creep).

The juxtaposition of the bipolar layers 102 and frame 104 provides multiple advantages relative to conventional AIB designs. For example, the frame 104 can seal and be positioned proximate to each of the bipolar layers 102 without encompassing the bipolar layers 102. As such, the frame 104 can have a smaller thickness, as it does not need to account for the thickness and compression of the bipolar layers 102. In contrast to other battery designs in which a conductive material (e.g., the bipolar layers) is contained within the frame 104 and which thus must have ‘pockets’ carefully designed to correspond to the frame, embodiments of the disclosed technology avoid this issue, as the frame 104 and its characteristics (e.g., thickness, material, etc.) do not need to be based on the proximate conductive material. The absence of a ‘pocket’ in the frame 104 and embodiments of the disclosed technology allows a wider selection of material to be used for the bipolar layers 102, thereby offering more flexibility to manufacturers to tailor characteristics of the overall cell to a particular application.

FIG. 1D shows the device 100 of FIGS. 1A and 1B further containing aqueous electrolyte fluid 120, and FIG. 1E is a cross-sectional view of the bipolar AIB device 100 shown in FIG. 1D along line 1E. As described herein, the frame 104 of the device 100 can include one more ports, openings, or vent holes 118a-b configured to receive fluid (e.g., the electrolyte fluid 120) and/or enable gas to escape from the area encapsulated by the frame 104 and/or sealed with the bipolar layers 102. As shown in FIGS. 1D and 1E, the electrolyte fluid 120 can be fed, via the port 118b, to the area of the device 100 encapsulated by the frame 104, and air can escape from the same area via the port 118a. In doing so, the added electrolyte fluid 120 can “flood” the cell to surround or drown the anode 106 and the cathode 112 (and their respective anode and cathode portions 108, 116) in the electrolyte fluid 120, and can fill any porosity of the separator 110. It is worth noting that several lead and nickel-based chemistries use a non-flooded design to have porosity for evolved oxygen to diffuse to the anode for reduction. AIBs are, in general, anode limited and does not evolve oxygen. As shown in FIG. 1E, the bipolar layers 102 previously described with reference to FIGS. 1A and 1B are disposed proximate opposing sides of the frame 104 and/or the flooded cell.

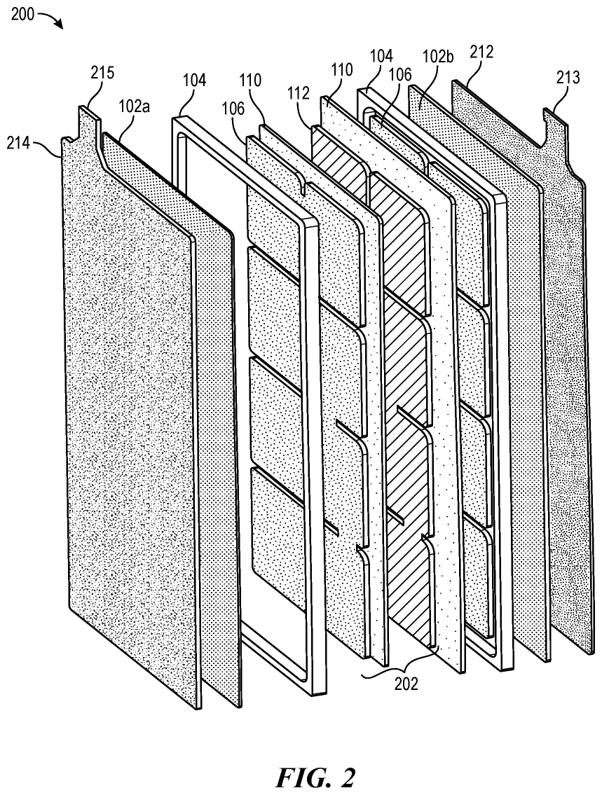

FIG. 2 shows a partially schematic exploded view of an example of a bipolar AIB block 200 (“block 200”) according to various embodiments described herein. For illustration purposes, the block 200 contains two bipolar AIB battery cells 201 (i.e., two combinations of the anode 106, separator 110, and cathode 110). It is noted that the separator 110 and cathode 112 for one of the cells is not viewable in FIG. 2. Each battery cell 201 is substantially encapsulated within the frame 104, which is disposed between the bipolar layers 102 on opposing sides thereof. As shown in FIG. 2, the block 200 further includes current collectors peripheral to each of the outermost bipolar layers 102a,b, including a cathode current collector 212 peripheral to the bipolar layer 102b and an anode current collector 214 peripheral to the bipolar layer 102a. In some embodiments, the bipolar layer 102b is disposed between (i) two adjacent cells of the block 200 and (ii) the anode current collector 214 and the cathode current collector 212, without directly contacting either of the two current collectors 212, 214. In some embodiments, one or more of the bipolar layers 102a,b may include a portion that extends past an edge of the frame 104 and is electrically connected to additional circuit elements, e.g., for the purposes of monitoring or balancing cells. The current collectors 212, 214 can electrically connect a plurality of individual cells in series to form one or more bipolar AIB blocks. In some embodiments, the current collectors 212, 214 may comprises copper and/or aluminum and be approximately or at least 0.1 mm. The current collectors 212, 214 are designed to be sufficiently conductive for AIB applications. In some embodiments, the current collectors 212, 214 may be thicker of thinner based on variable costs, chemistries with different energy densities, and system sizes. In some embodiments, selection and design for the current collectors 212, 214 can have different materials and/or material requirements relative to one another. For example, the anode current collector 214 may be exposed to lower potentials and higher pH conditions, e.g., due to localized hydrogen evolution from the aqueous electrolyte. As such, in some embodiments the anode current collector 214 can comprise material(s) that are stable in less acidic but basic environments, which may result in oxide formation on the surface. The cathode current collector 212 may be exposed to higher potentials and, in the event of water oxidation, should be configured to resist the low pH acidic environment at high potentials.

It is noted that bipolar layers in an MPB have high in-plane conductivity, because current travels primarily “in-plane” along a length or width of each bipolar layer, as opposed to “through-plane.” As such, current collectors for MPB designs can have very high conductivity, and thus require thicker collectors. This thickness requirement, however, contributes to the high cost burden of current collectors in traditional MPB designs. Conventionally, stainless steel is mostly stable in both the anode and cathode potential regions for AIB chemistry, but must be coated with conductive additives (e.g., carbon) or layered with graphite paper to make better contact and/or delay eventual surface degradation. In contrast to these conventional technologies, the current collectors 212, 214 of the disclosed technology do not contact the electrolyte environment, as they are positioned behind the adjacent bipolar layer 102 proximate to the terminal ends of the block 200. Therefore, the current collectors 212, 214 of the disclosed technology can be made of a variety of highly conductive materials including copper, aluminum, bronze, stainless steel alloys, or combinations thereof. In some embodiments, the current collectors 212, 214 do not have any protective coating. As shown in FIG. 2, the current collectors 212, 214 can have respective tabs 213, 215 that protrude from the top of the block 200 (or corresponding stack). As shown in FIG. 2, the tabs 213, 215 may extend in the same direction (e.g., top or bottom of the respective current collectors 212, 214).

In operation, the bipolar layers 102 can preferably withstand exposure to both the anode and cathode environments simultaneously, as well as ionic concentration gradients which neither current collector 212, 214 is exposed to. Therefore, the material selection for the bipolar layers 102 has more constraints from chemical compatibility than the equivalent monopolar layers. However, unlike MPB designs which utilize in-plane conduction, bipolar designs utilize through-plane conduction. As such, the current collectors 212, 214 for the bipolar design of the disclosed technology can be thinner and/or provide better conductivity, relative to an MPB design, which can decrease manufacturing costs. Likewise, the bipolar design of the disclosed technology can enable a shorter conductive path length due to the through-plane conduction, thereby allowing materials to be used that have much less bulk conductivity. In some embodiments, bipolar materials with less than 500 ohm-cm are preferred. Again, this expands the number of materials that may be used beyond only those expensive and conductive metals (e.g., stainless steel) that must be used for MPB designs.

The bipolar layers 102 can comprise a thin metal foil, and in some embodiments may be coated or surrounded with carbon and/or polymer materials to increase conductivity and/or reduce corrosion. For example, the bipolar layers 102 can comprise low-cost polymer sheets (e.g., polyethylene, polyurethane, polypropylene, and/or fluorinated polymers such as PTFE,) impregnated with conductive carbons (e.g., for electrical conductivity purposes) or other conductive polymer films. Such polymer-carbon composite materials are proficient for dispersing static electricity and are available at a significantly lower cost than the metal sheets required for more conventional MPB designs. In some embodiments, the bipolar layers 102 comprises graphite foil, which may be impregnated with polymer sheets, e.g., to provide adequate through-plane electrical conductivity while maintaining negligible ionic conductivity. In some embodiments, the bipolar layers 102 comprises a combination of a conductive carbon material and a polymer material, e.g., to achieve high electronic and low ionic conductivity. In some embodiments, the bipolar layer comprises one or more thin layers of the above-mentioned materials, in which each thin layer independently serves the purposes of electrical contact and ionic isolation.

FIG. 3 shows a partially schematic view of an example of a compressible sealable frame 300. The frame 300 can correspond to or include any of the features and functionality of the frame 104 described herein. As shown in FIG. 3, the frame 300 can include an outer structure 302 that defines an interior area 306 configured to receive a battery cell (i.e., an anode, separator, and cathode). The structure 302 can include one or more coupling holes 310, e.g., to provide alignment and durability in operation. In some embodiments, the coupling holes 310 can be configured to receive an alignment rod (e.g., the alignment rod 312 described with reference to FIG. 4) for alignment thereof, which may be performed by automatic means (e.g., a robot assembly). As described herein, the frame 300 can comprise an elastomer such as silicone rubber, isoprene or neoprene, combinations thereof, or any similar material(s) exhibiting compressibility and long-term stability in the battery AIB environment. In some embodiments, the frame 300 is formed via injection molding, extrusion, or additive manufacturing. Fabrication of the frame 300 may also include specific post-processing such as pressing or extrusion of features, or surface treatments. The structure 302 and/or surface of the frame 300 can have additional features configured to enhance pressure distribution and/or evenness of compression throughout the frame 300. For example, the structure 302 can include a groove 312 extending around the entire surface to create areas of higher and lower compressive force and help align the frames initially.

The frame 300 and/or structure 302 can also include one or more ports 318a,b (collectively referred to as “ports 318”), in which one of the ports 318 allows for transfer of electrolyte fluid and/or gas removal during use, and the other one of the ports 318 serves allows for electrolyte fluid filling and/or gas removal. In some embodiments, the ports 318 can be fluidly connected to a common gas space, such that gas from each cell of a stack can be vented safely through a single pressure relief valve (e.g., as described with reference to FIG. 4). As an example, oxygen and hydrogen, produced from the electrolysis of water when the cell or stack is in operation, can escape via one or more of the ports 318 and thereby prevent these gasses from building up inside of the battery. In some embodiments, one or more of the ports 318 may be relatively small and act as a septum, allowing gas to escape to an external area outside of the stack. This external area can be contained by a secondary containment, while preventing cross contamination between the cells.

As previously described, one of the ports 318 can be are used for electrolyte injection and infiltration during the initial fabrication of the stack, and/or to flood the cell with electrolyte to ensure the anode and cathode portions are substantially covered. Simultaneously to flooding the cell, gasses can be displaced and removed from one of the ports 318. In some embodiments, the port 318 used to inject the electrolyte can be sealed after use, either permanently or temporarily to allow for future maintenance. In some embodiments, one of the ports 318 may be fluidically connected to a common manifold to facilitate electrolyte filling of multiple cells at once. In such embodiments, measures are taken to remove the electrolyte from the common manifold prior to battery activation and operation in order to remove any ionic shunting between the cells.

FIG. 4 shows an example of a gas ventilation handling system 400 (“system 400”) according to various embodiments described herein. As shown in FIG. 4, the system 400 is incorporated into a battery stack including a plurality of battery cells, as described herein. The system 400 includes a common gas space 403, and a pressure relief valve (“PRV”) 405 in fluid communication with the common gas space 403. The common gas space 403 can be configured to vent gas to an external area. The common gas space 403 is in fluid communication with one or more ports 418a (e.g., the ports 118, 318) of respective layers 404 (e.g., the frame 104, 300), and may be used to pull a partial vacuum on the internal battery stack, e.g., to remove entrapped gas in the electrodes and/or facilitate electrolyte addition to the battery cell. In some embodiments, the system 400 may include one or more additional ports to fluidly connect to the environment outside of the battery stack. Such ports may be plugged during regular usage but used during assembly for electrolyte addition and possibly as a backup, e.g., in case the PRV 405 fails. The PRV 405 can be a one-way PRV 405, and in some embodiments can include a water or salt trap, or related means to avoid contamination or plugging of the PRV 405.

### IV. Battery Stacks

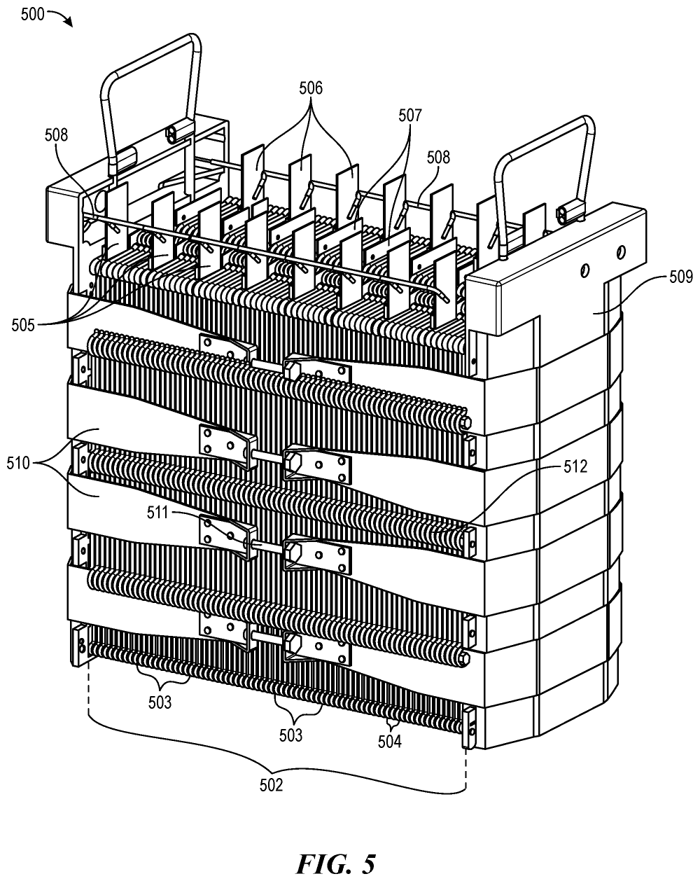

FIG. 5 shows a partially schematic view of an example of a bipolar AIB system 500 (“system 500”) according to various embodiments described herein. The system 500 comprises a battery stack 502, and two compression plates 509 compressing the stack 502 therebetween. The compression plates 509 can allow the system 500 to achieve better sealing of the stack 502, as well as improved electrical contact. The stack 502 can comprise any number of AIB blocks 503, which can generally correspond to any of the blocks (e.g., block 200) described elsewhere herein. In some embodiments, the system 500 comprises a container that substantially contains the stack 502, e.g., to prevent leaking of the electrolyte to the environment. As shown in FIG. 5, the system 500 can include insulating layers 507 disposed between two adjacent blocks 503, between one of the compression plates 509 at a first terminal end and its adjacent block 503, and between another compression plate 509 at a second terminal end opposite the first terminal end and its adjacent block. In some embodiments, the insulating layer 507 may be compressible. For example, the insulating layer 507 can be a solid sheet of the same material as the frames (e.g., the frame 104, 300, 404) previously described. In some embodiments, the insulating layer 507 can be rigid, and can provide structural support to prevent uneven distribution of pressure for the lifetime of the stack 502.

The system 500 can include current collector tabs 505, 506, and electrical connections 508 coupled to each block 503 via the current collector tabs 505, 506. The electrical connections 508 may be connected in series (e.g., anode to cathode), or in parallel (e.g., anode to anode, cathode to cathode), e.g., to achieve a desired product voltage and capacity. In some embodiments, the electrical connections 508 can be made by mechanically attaching a wire or other coupling element to each of the current collector tabs 505, 506. Additionally or alternatively, the electrical connections 508 may be formed by welding or soldering the current collector tabs 505, 506 to one another or to a common busbar. In such embodiments, the busbars can be connected to commercially available electrical connectors outside the battery stack.

The compression plates 509 can be made of metallic or polymer materials, depending on the design and compressive forces required over lifetime usage. As shown in FIG. 5, the system 500 includes compression bands 510 that distribute compression across the plates 509, and bolt connections 511 on each of the compression bands 510. The bolt connections 511 are the originating compressive force in the compression bands 510 originate. To achieve and maintain the desired tension through the product lifetime, the bolt connections 511 may have a specific spring component and depth. In other embodiments, threaded steel rods may provide compression to the stack 502 in a similar manner, and they also may have a specific spring component. In addition to achieving the desired sealing through compression, other methods such as thermal welding, adhesive bonding, or a combination thereof may be applied to facilitate sealing between frames of each block 503. The applied axial load may be decoupled from the sealing function, and may be optimized for minimizing overall stack impedance only. Also, such sealing may allow the reduction of the durometer of the elastomer employed in the frame, and thus improve its rigidity and amenability for automated robotic placement.

Maintaining even pressure distribution throughout the lifetime of the stack 502 can improve performance thereof. In some embodiments, the system 500 can include additional alignment features. For example, each of the frames can include alignment features 512, which can allow for an alignment device (e.g., a metal rod) to be inserted therethrough to align the stack 502 when assembled, e.g., to provide additional support and resistance to sag or misalignment throughout the lifetime of the stack 502. In some embodiments, the alignment features 512 may be the same features which provide compression (i.e., the threaded rods 411).

In some embodiments, the number of the cells are customized to achieve a desired voltage for the block and can be an odd or even number. For example, 8 cells can be arranged in a block to achieve 12 volts (assuming a nominal 1.5 V cell voltage). In some embodiments, the number of the cells in a block ranges between 2 cells and 64 cells. In some embodiments, the number of the cells in a block can be at least 4, 8, 12, 16, 20, 24, 28, 32, 36, 40, 44, 48, 52, 56, 60, 64, 72, 80, 88, 96, 104, 112, or 120. Likewise, the number of the blocks can be customized to achieve a desired capacity for the bipolar AIB stack and can be an odd or even number. For example, 8 blocks can be arranged in a stack. In some embodiments, the number of the blocks in a stack ranges between 2 blocks and 120 blocks. In some embodiments, the number of the blocks in a stack is 4, 8, 12, 16, 20, 24, 28, 32, 36, 40, 44, 48, 52, 56, 60, 64, 72, 80, 88, 96, 104, 112, or 120.

A given number of identical cell layers may be assembled in series into a block. A block has the same amp*hour capacity as the cells in series, and the sum of all of the cells' voltages. For example, a block of 8 cells with 1.5 V each has a 12 V nominal voltage. A given number of identical blocks can be connected in parallel to achieve the final capacity of a battery stack. The stack therefore has the voltage of each block, and the sum of the capacity of each block. For example, a stack with 8 blocks of 8 A*hours each will have a total of 64 A*hours of capacity.

The layer-by-layer design and simple materials allows a cost-effective mass production of the battery stacks at a large scale. For example, a drop-table would allow a stack of arbitrary size to be built using simple 2-axis pick-and-place machinery as almost every layer will be identical, with only small additions between the blocks. Different assemblies such as [2-layer], [8-layer, 1 block], and [8-layer, 4 block] of the can be produced in a highly repeatable order. Once assembled, the stack 502 is compressed using a combination of top-applied force and torque applied to the load-bearing straps. This combination allows for uniform and careful application of force to the entire stack to create a properly sealed and balanced stack. The final step of assembly is the gas and electrolyte handling during the infiltration process, which can be enabled via the ports disclosed herein. In such embodiments, the port that serves the common gas space is connected to a vacuum line instead of the PRV, and functions as a means of evacuating the gas from the battery as-built. Simultaneously, the other port is used to introduce electrolyte into the electrodes of each cell and prepare them for cycling.

### V. Conclusion

It will be apparent to those having skill in the art that changes may be made to the details of the above-described embodiments without departing from the underlying principles of the disclosed technology. In some cases, well known structures and functions have not been shown or described in detail to avoid unnecessarily obscuring the description of the embodiments of the disclosed technology. Although steps of methods may be presented herein in a particular order, alternative embodiments may perform the steps in a different order. Similarly, certain aspects of the disclosed technology disclosed in the context of particular embodiments can be combined or eliminated in other embodiments. Furthermore, while advantages associated with certain embodiments of the disclosed technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising,” “including,” and “having” should be interpreted to mean including at least the recited feature(s) such that any greater number of the same feature and/or additional types of other features are not precluded.

Reference herein to “one embodiment,” “an embodiment,” “some embodiments” or similar formulations means that a particular feature, structure, operation, or characteristic described in connection with the embodiment can be included in at least one embodiment of the disclosed technology. Thus, the appearances of such phrases or formulations herein are not necessarily all referring to the same embodiment. Furthermore, various particular features, structures, operations, or characteristics may be combined in any suitable manner in one or more embodiments.

Unless indicated to the contrary, the numerical parameters set forth in this specification are approximations that may vary depending upon the desired properties sought to be obtained by the disclosed technology. At the very least, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10, i.e., any and all subranges having a minimum value of equal to or greater than 1 and a maximum value of equal to or less than 10, e.g., 5.5 to 10.

The disclosed technology is illustrated, for example, according to various aspects described below. Various examples of aspects of the disclosed technology are described as numbered examples (1, 2, 3, etc.) for convenience. These are provided as examples and do not limit the disclosed technology. It is noted that any of the dependent examples may be combined in any combination, and placed into a respective independent example. The other examples can be presented in a similar manner.

1. A bipolar aqueous intercalation battery (AIB), comprising:
an anode;
a cathode;
a separator disposed between the anode and the cathode, wherein the separator is porous and configured to provide electronic isolation and ionic conductivity between the anode and the cathode;
a frame entirely surrounding edges of the anode, the cathode and the separator, the frame comprising a compressible material; and
bipolar layers including a first bipolar layer at a first side of the frame and a second bipolar layer at a second side of the frame opposite the first side,
wherein the first bipolar layer and the second bipolar layer each abut the frame, such that the frame, the first bipolar layer and the second bipolar layer together are configured to contain an electrolytic fluid and form a water-tight seal around the anode, the cathode, and the separator.

2. The bipolar AIB of any one of the examples herein, wherein the anode, the cathode, and the separator together comprise a cell, and wherein, in operation, a through-plane resistance of the cell is within a range of 10-100 ohms·centimeters.

3. The bipolar AIB of any one of the examples herein, wherein the first bipolar layer and the second bipolar layer comprise polymer sheets impregnated with carbon materials.

4. The bipolar AIB of any one of the examples herein, wherein the anode has an array of anode portions and the cathode has an array of cathode portions, and wherein individual anode portions are aligned with corresponding individual cathode portions.

5. The bipolar AIB of example 4, wherein the individual anode portions or the individual cathode portions have at least four sides, each of the four sides having a length of 1-5 centimeters.

6. The bipolar AIB of any one of the examples herein, wherein at least one of the anode or the cathode comprises a pellet, free-standing sheet, or slurry.

7. The bipolar AIB of any one of the examples herein, wherein the frame comprises a first opening configured to receive the electrolyte fluid, and a second opening configured to vent gases formed during operation of the bipolar AIB.

8. The bipolar AIB of any one of the examples herein, wherein the frame is an elastomer selected from the group consisting of: silicone rubber, isoprene, and neoprene.

9. The bipolar AIB of any one of the examples herein, wherein the frame is a single component comprising a continuous surface extending along an entirety of the frame.

10. The bipolar AIB of any one of the examples herein, wherein:
the anode, the separator, and the cathode are in a compressed state via the frame and bipolar layers,
the frame has a first thickness, and
the anode, the separator, and the cathode in an uncompressed state have a combined second thickness greater than or equal to the first thickness.

11. The bipolar AIB of any one of the examples herein, wherein the anode, the cathode, and the separator together comprise a cell, the bipolar AIB further comprising a top of charge resistance of 0.01-0.1 ohms per cell.

12. The bipolar AIB of any one of the examples herein, further comprising an electrode loading within a range of 100-500 mg/cm².

13. A bipolar aqueous intercalation battery (AIB) stack, comprising:
a first compression plate;
a second compression plate;
bipolar AIB blocks disposed between the first compression plate and the second compression plate, individual bipolar AIB blocks comprising—
   an anode current collector,
   a cathode current collector, and
   AIB cells disposed between the anode current collector and the cathode current collector, individual AIB cells comprising an anode, a cathode, and a separator disposed between the anode and the cathode, wherein the separator is porous and configured to provide electronic isolation and ionic conductivity between the anode and the cathode; and
an insulating layer disposed between adjacent bipolar AIB blocks.

14. The bipolar AIB stack of any one of the examples herein, further comprising bipolar layers, individual bipolar layers disposed between adjacent AIB cells, one of the AIB cells and the anode current collector, and another one of the AIB cells and the cathode current collector.

15. The bipolar AIB stack of example 14, wherein the individual bipolar layers comprise a metal foil, polymer sheet, or graphic foil.

16. The bipolar AIB stack of any one of the examples herein, further comprising a first bipolar layer at a first side of the frame and a second bipolar layer at a second side of the frame opposite the first side, wherein the first bipolar layer and the second bipolar layer each abut the frame such that the frame, the first bipolar layer and the second bipolar layer together are configured to form a water-tight seal around the anode, the cathode, and the separator.

17. The bipolar AIB stack of example 16, wherein the individual bipolar layers comprise a metal foil coated with carbon or polymer materials.

18. The bipolar AIB stack of any one of the examples herein, wherein at least one of the anode current collector or the cathode current collector comprises aluminum, copper, bronze, or stainless steel alloy.

19. The bipolar AIB stack of any one of the examples herein, wherein, in operation, the through-plane resistance of individual AIB cells is within a range of 10-100 ohms·centimeters.

20. The bipolar AIB stack of any one of the examples herein, wherein two of the bipolar AIB blocks are connected in parallel by connecting the cathode current collector to a first busbar and the anode current collector to a second busbar, and wherein the bipolar AIB blocks are connected by welding or soldering the cathode and anode current collectors.

21. A bipolar aqueous intercalation battery (AIB) cell comprising an anode layer, a cathode layer, a separator disposed between the anode layer and the cathode layer, and a compressible sealing frame (CSF), wherein the anode layer, the cathode layer, and the separator are surrounded by the CSF.

22. The bipolar AIB cell of example 21, wherein the anode layer is an intercalation-type negative electrode, and the cathode layer is an intercalation-type positive electrode.

23. The bipolar AIB cell of example 21 or example 22, wherein the separator is a porous separator that provides electronic isolation and ionic conductivity within the cell.

24. The bipolar AIB stack of any one of examples 21-23, wherein the CSF is a single, integrated piece.

25. The bipolar AIB stack of any one of examples 21-24, wherein the CSF is made of an elastomer selected from the group consisting of silicone rubber, isoprene and neoprene.

26. A bipolar aqueous intercalation battery (AIB) stack comprising:
a first compression plate;
a second compression plate;
one or more bipolar AIB blocks disposed between the first and second compression plates; and
one or more insulating layers,
wherein two adjacent AIB blocks are separated by an insulating layer disposed in between,
wherein each bipolar AIB block comprises an anode current collector, a cathode current collector, a plurality of AIB cells of any one of examples 1-5 disposed between the current collectors, and a plurality of bipolar layers, and
wherein two adjacent AIB cells are separated by a bipolar layer disposed in between.

27. The bipolar AIB stack of example 26, wherein a bipolar layer is disposed between the AIB cell and the anode current collector, between each AIB cell, and between the AIB cell and the cathode current collector.

28. The bipolar AIB stack of example 26 or example 27, wherein a bipolar layer is disposed between the AIB cell and the cathode layer.

29. The bipolar AIB stack of any one of examples 26-28, wherein the bipolar layer comprises one or more thin layers of electrically conductive material having low ionic conductivity.

30. The bipolar AIB stack of any one of examples 26-29, wherein the bipolar layer is made of a metal foil, a polymer sheet, or a graphite foil.

31. The bipolar AIB stack of example 30, wherein the metal foil is coated with carbon or polymer materials, the polymer sheet is impregnated with conductive carbon, or the graphite foil is impregnated with a polymer sheet.

32. The bipolar AIB stack of any one of examples 26-29, wherein the bipolar layer comprises a combination of a conductive carbon material and a polymer material.

33. The bipolar AIB stack of any one of examples 26-32, wherein the height and width of the bipolar layer is substantially the same as those of the CSF.

34. The bipolar AIB stack of any one of examples 26-33, wherein the anode current collector or the cathode current collector is made of aluminum, copper, bronze, or stainless alloy.

35. The bipolar AIB stack of any one of examples 26-34, wherein the two or more blocks are connected in parallel by connecting the cathode-side of the current collectors to a first busbar and the anode-side of the current collectors to a second busbar.

36. The bipolar AIB stack of any one of example 15, wherein the blocks are connected by welding or soldering the current collectors.

I/We claim:

1. A bipolar aqueous intercalation battery (AIB), comprising:
an anode;
a cathode;
a separator disposed between the anode and the cathode, wherein the separator is porous and configured to provide electronic isolation and ionic conductivity between the anode and the cathode;
a frame entirely surrounding edges of the anode, the cathode and the separator, the frame comprising a compressible material; and
bipolar layers including a first bipolar layer at a first side of the frame and a second bipolar layer at a second side of the frame opposite the first side,
wherein the first bipolar layer and the second bipolar layer each abut the frame, such that the frame, the first bipolar layer and the second bipolar layer together are configured to contain an electrolytic fluid and form a water-tight seal around the anode, the cathode, and the separator.

2. The bipolar AIB of claim 1, wherein the anode, the cathode, and the separator together comprise a cell, and wherein, in operation, a through-plane resistance of the cell is within a range of 10-100 ohms·centimeters.

3. The bipolar AIB of claim 1, wherein the first bipolar layer and the second bipolar layer comprise polymer sheets impregnated with carbon materials.

4. The bipolar AIB of claim 1, wherein the anode has an array of anode portions and the cathode has an array of cathode portions, and wherein individual anode portions are aligned with corresponding individual cathode portions.

5. The bipolar AIB of claim 4, wherein the individual anode portions or the individual cathode portions have at least four sides, each of the four sides having a length of 1-5 centimeters.

6. The bipolar AIB of claim 1, wherein at least one of the anode or the cathode comprises a pellet, free-standing sheet, or slurry.

7. The bipolar AIB of claim 1, wherein the frame comprises a first opening configured to receive the electrolyte fluid, and a second opening configured to vent gases formed during operation of the bipolar AIB.

8. The bipolar AIB of claim 1, wherein the frame is an elastomer selected from the group consisting of: silicone rubber, isoprene, and neoprene.

9. The bipolar AIB of claim 1, wherein the frame is a single component comprising a continuous surface extending along an entirety of the frame.

10. The bipolar AIB of claim 1, wherein:
the anode, the separator, and the cathode are in a compressed state via the frame and bipolar layers,
the frame has a first thickness, and
the anode, the separator, and the cathode in an uncompressed state have a combined second thickness greater than or equal to the first thickness.

11. The bipolar AIB of claim 1, wherein the anode, the cathode, and the separator together comprise a cell, the bipolar AIB further comprising a top of charge resistance of 0.01-0.1 ohms per cell.

12. The bipolar AIB of claim 1, further comprising an electrode loading within a range of 100-500 mg/cm².

13. A bipolar aqueous intercalation battery (AIB) stack, comprising:
a first compression plate;
a second compression plate;
bipolar AIB blocks disposed between the first compression plate and the second compression plate, individual bipolar AIB blocks comprising—
an anode current collector,
a cathode current collector, and
AIB cells disposed between the anode current collector and the cathode current collector, individual AIB cells comprising an anode, a cathode, and a separator disposed between the anode and the cathode, wherein the separator is porous and configured to provide electronic isolation and ionic conductivity between the anode and the cathode; and
an insulating layer disposed between adjacent bipolar AIB blocks.

14. The bipolar AIB stack of claim 13, further comprising bipolar layers, individual bipolar layers disposed between adjacent AIB cells, one of the AIB cells and the anode current collector, and another one of the AIB cells and the cathode current collector.

15. The bipolar AIB stack of claim 14, wherein the individual bipolar layers comprise a metal foil, polymer sheet, or graphic foil.

16. The bipolar AIB stack of claim 13, further comprising a first bipolar layer at a first side of the frame and a second bipolar layer at a second side of the frame opposite the first side, wherein the first bipolar layer and the second bipolar layer each abut the frame such that the frame, the first bipolar layer and the second bipolar layer together are configured to form a water-tight seal around the anode, the cathode, and the separator.

17. The bipolar AIB stack of claim 16, wherein the individual bipolar layers comprise a metal foil coated with carbon or polymer materials.

18. The bipolar AIB stack of claim 13, wherein at least one of the anode current collector or the cathode current collector comprises aluminum, copper, bronze, or stainless steel alloy.

19. The bipolar AIB stack of claim 13, wherein, in operation, the through-plane resistance of individual AIB cells is within a range of 10-100 ohms·centimeters.

20. The bipolar AIB stack of claim 13, wherein two of the bipolar AIB blocks are connected in parallel by connecting the cathode current collector to a first busbar and the anode current collector to a second busbar, and wherein the bipolar AIB blocks are connected by welding or soldering the cathode and anode current collectors.
